(19) United States
(12) Patent Application Publication
(10) Pub. No.: US 2018/0198295 A1
(43) Pub. Date: Jul. 12, 2018

(54) Portable Charging Luggage

(71) Applicant: Maria Warney, Springhill, FL (US)

(72) Inventor: Maria Warney, Springhill, FL (US)

(21) Appl. No.: 15/403,172

(22) Filed: Jan. 11, 2017

(51) Int. Cl. H02J 7/00; A45C 13/26; A45C 5/03; A45C 15/00

(52) U.S. Cl. CPC H02J 7/0027; H02J 7/0045; A45C 2013/267; A45C 5/03; A45C 15/00; A45C 13/262

(57) ABSTRACT

The current invention is a is a portable charger in a suitcase or luggage case than can charge electronic device on the go. There will be a power station that is attached to a rechargeable power supply like a battery. The power station will be located under an access panel. The power station will have USB charging ports on the top and may have other types of charging ports as well. The portable charge will provide a user with a power source to charge their electric devices while traveling.

### CROSS-REFERENCES TO RELATED APPLICATIONS (IF ANY)

None.

### BACKGROUND

### 1. Field of the Invention

This invention relates to a portable charger and system and more particularly one that is in or part of luggage.

### 2. Description of Prior Art

People businesses sometimes depend on their phone or electronics to keep them attached to their office or customers. Running late for a flight, with a dead phone can be a real significant problem. The same as arriving at a busy airport and all the outlet sources are taken.

There is still room for improvement in the art.

### SUMMARY OF THE INVENTION

The current invention is a portable charger in a suitcase or luggage case than can charge electronic devices on the go.

The invention can be used with any size suitcase of luggage. The luggage will have a frame with a power station attached to the top of the frame. The power station will be located under an access panel that covers the handle of the suitcase. The power station will have USB charging ports on the top and may have other types of charging ports as will.

The power station will be connected to a backup battery. The battery is removable and stored in a fold in the back of the suit case under a back cover.

The objective of this invention is to provide a user with a power source to charge their electric devices while traveling.

It is an improvement over the current art.

### BRIEF DESCRIPTION OF THE DRAWINGS

Without restricting the full scope of this invention, the preferred form of this invention is illustrated in the following drawings:

FIG. 1 is a view of a luggage case with the invention;

FIG. 2 shows the handle of the luggage case being extended;

FIG. 3 displays the luggage side open showing the battery pack;

FIG. 4 shows the charging plug station;

FIG. 5 shows another view of the charging plug station;

FIG. 6 shows the rechargeable battery pack and cord; and

FIG. 7 shows the face of the charging station.

### DESCRIPTION OF THE PREFERRED EMBODIMENT

There are a number of significant design features and improvements incorporated within the invention.

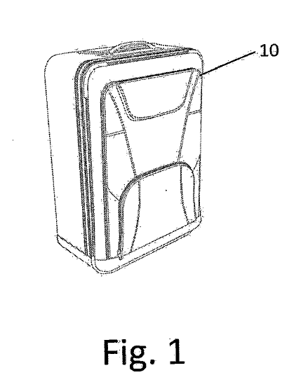

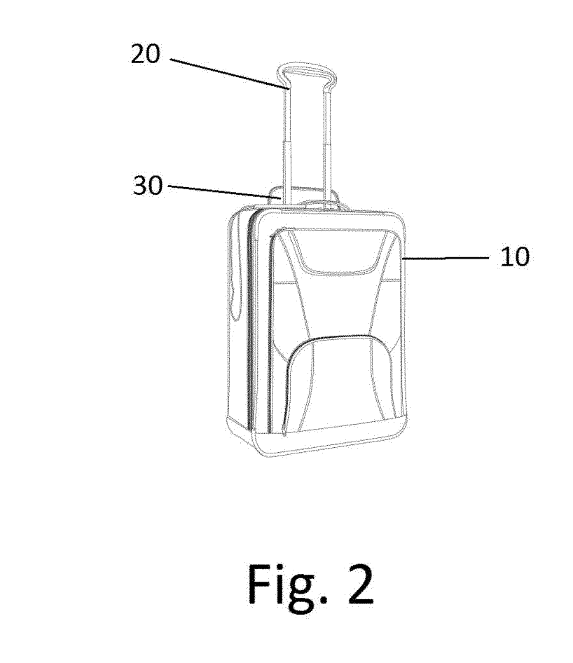

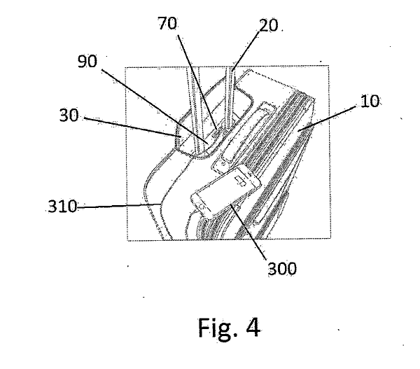

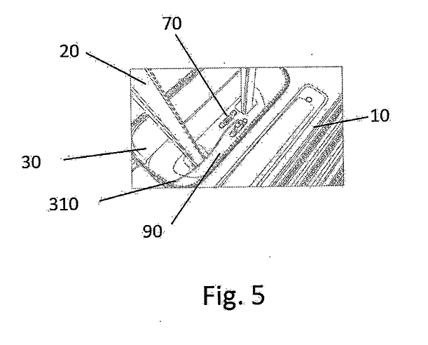

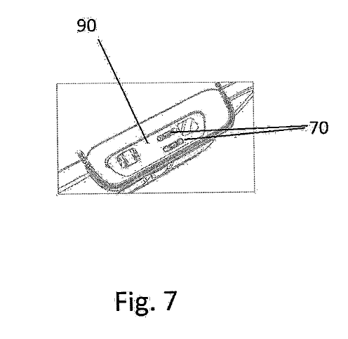

The current invention is a charging station 1 as shown in FIGS. 1-7 that can be contained within luggage 10 or baggage as shown in FIG. 1, especially with carry-on sized luggage 10. In the preferred embodiment, the luggage 10 will have an extendable handle 20 as shown in FIG. 2. When not extended the handle 20 will collapse into the body of the luggage 10 under an access panel 30 that covers the handle of the suitcase. In the preferred embodiment, when closed the access panel 30 would be secured with a zipper system although other securing means like a hook and loop fastener system can be used. The current invention has a power station 90 that is located under the access panel 30.

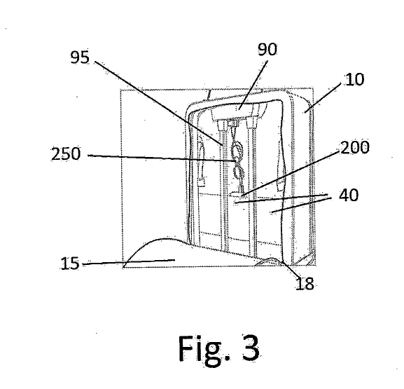

As shown in FIG. 3, the luggage 10 will have a frame 95 with a power station 90 attached to the top of the frame 95. The power station 95 will be connected to the backup battery 100 using a power cord 250 which plugs into the battery 100 and the power station 95. In the preferred embodiment, the power cord 250 plugs into a slot in the bottom of the power station 90. The battery 100 is rechargeable and removable.

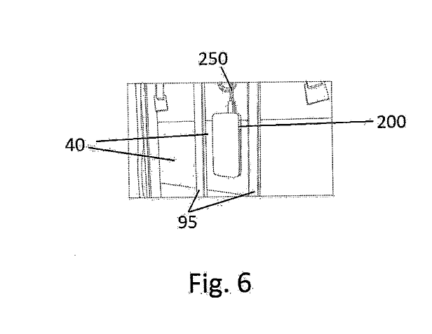

In the preferred embodiment that battery 100 is stored in a pocket 40 in the back of the suit case under a back cover 15 as shown in FIGS. 3 and 6. Multiple batteries 200 can be stored in a plurality of pockets 40 in the back of the luggage 10 supported by the frame 95. The back cover 15 closes with the use of a closing means like a zipper 18.

The power station 90 will have USB charging ports 70 on the top and may have other types of charging ports as well as shown in FIGS. 3, 5 and 7. The USB charging ports 70 can be used to charge a user's electronics such as a cell phone 300 using a USB power cord 310 or other power cord to connect the electronic device to the power station 90.

The power station 90 will transfer the electrical output from the batteries 200 to the charging ports 70 to provide power to charge electronic devices when a power outlet is not available. The batteries 200 can be switched out to another charged battery 200 when they lose charge. After losing charge, if the batteries is rechargeable it can be recharged and used again.

The power station 90 can also have its own internal chargeable battery 200 so that an outside battery and power cord 250 would not be necessary.

The user can also store their devices inside the luggage 10 in the pockets 40 to charge them.

Operation

The user opens up the access panel to access the charging ports and plugs in their electronic device. After charged simply zip up the panel and stow away the bag.

Advantages

The current invention removes the hassles of waiting for an outlet to open up. It stows safely and easy. Having a power source right into your luggage is not only convenient but easy to use.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A luggage device comprising:
Having a power station with charging ports where the power station is connected to a plurality of batteries.

2. A luggage device according to claim 1 further comprising:
Having the charging ports be USB ports.

3. A luggage device according to claim 1 further comprising:
Having a luggage frame and having the power station connected to the frame.

4. A luggage device according to claim 1 further comprising:
Having the luggage have a top and having an access panel at the top of the luggage.

5. A luggage device according to claim 4 further comprising:
Having the access panel have a closing means.

6. A luggage device according to claim 4 further comprising:
Having an extendable handle located the top of the luggage and extend out from under the access panel.

7. A luggage device according to claim 1 further comprising:
Having a back and a back cover that opens up.

8. A luggage device according to claim 7 further comprising:
Having a plurality of pockets in back that are covered by the back cover.

9. A luggage device according to claim 8 further comprising:
Having the battery stored in a pocket.

10. A luggage device according to claim 9 further comprising:
Having electronics stored and charged in a pocket.

11. A luggage device according to claim 10 further comprising:
Connecting a plurality of electronic devices to the power station to be charged.

12. A luggage device according to claim 11 further comprising:
Having the connection through a power cord.

13. A charging device comprising:
Having a power station with charging ports where the power station is connected to a plurality of batteries and having the power station be connected to a place of luggage.

14. A charging device according to claim 13 further comprising:
Having the charging ports be USB ports.

15. A charging device according to claim 13 further comprising:
Having the luggage have a luggage frame and connecting the power station to the frame.

16. A charging device according to claim 13 further comprising:
Having the luggage have a top and having an access panel at the top of the luggage.

17. A charging device according to claim 16 further comprising:
Having the access panel have a closing means.

18. A charging device according to claim 13 further comprising:
Having a back and a back cover that opens up and having a plurality of pockets in back that are covered by the back cover.

19. A charging device according to claim 13 further comprising:
Having the battery stored in a pocket.

20. A process using the device according to claim 13.
